(19) United States
(12) Patent Application Publication
(10) Pub. No.: US 2025/0014550 A1
(43) Pub. Date: Jan. 9, 2025

(54) MUSICAL DEVICE

(71) Applicant: YAMAHA CORPORATION, Hamamatsu-shi (JP)

(72) Inventor: Jun ISHII, Hamamatsu-shi (JP)

(21) Appl. No.: 18/891,350

(22) Filed: Sep. 20, 2024

Related U.S. Application Data
(63) Continuation of application No. PCT/JP2023/009662, filed on Mar. 13, 2023.

(30) Foreign Application Priority Data
Mar. 24, 2022 (JP) 2022-049170

(51) Int. Cl. G10H 1/18

(52) U.S. Cl. CPC G10H 1/18

(57) ABSTRACT

A music device according to an embodiment of the present disclosure comprises a plurality of sensors that detect a movement of a plurality of performance control elements, respectively, the plurality of performance control elements including at least three performance control elements, a first transmitter that serially transmits identification information to identify a first group of data and the first group of data, using a first predefined number of data channels in time-division of a first predefined number of cycles, and a first receiver that identifies the first group of data from data serially received from the first transmitter based on the identification information. The first predefined number of data channels includes at least two data channels, the first predefined number of cycles includes at least two cycles. The first group of data includes information indicating a detection result output from each of the plurality of sensors.

### CROSS-REFERENCE TO RELATED APPLICATIONS

This application is a Continuation of International Patent Application No. PCT/JP2023/009662, filed on Mar. 13, 2023, which claims the benefit of priority to Japanese Patent Application No. 2022-049170, filed on Mar. 24, 2022, the entire contents of which are incorporated herein by reference.

### FIELD

The present disclosure relates to a musical device.

### BACKGROUND

A time division multiplexing (TDM) method employed in digital communication is a method in which data is time-divided and transmitted sharing the same transmission line. Using the TDM method makes it possible to perform communication efficiently.

For example, JP Patent No. 4618354 discloses a musical device in which physical information corresponding to a displacement of a performance control element is captured by a DSP, and driving information is output from the DSP to a driving unit that drives the performance control element. In JP Patent No. 4618354, it is proposed that input/output of data for 96 channels is controlled in a time-division manner by six serially connected ASICs.

### SUMMARY

According to an embodiment of the present disclosure, there is provided a musical device comprising a plurality of sensors that detect a movement of a plurality of performance control elements, respectively, the plurality of performance control elements including at least three performance control elements, a first transmitter that serially transmits identification information to identify a first group of data and the first group of data, using a first predefined number of data channels in time-division of a first predefined number of cycles, wherein the first group of data includes at least three pieces of data, the first predefined number of data channels includes at least two data channels, the first predefined number of cycles includes at least two cycles, and a number of the plurality of performance control elements and a number of the pieces of data of the first group of data is larger than the first predefined number of data channels, and a first receiver that identifies the first group of data from data serially received from the first transmitter based on the identification information, wherein the first group of data includes information indicating a detection result output from each of the plurality of sensors.

According to an embodiment of the present disclosure, there is provided a musical device comprising a plurality of driving units that drive a plurality of performance control elements, respectively, the plurality of performance control elements including at least three performance control elements, a first transmitter that serially transmits identification information to identify a first group of data and the first group of data, using a first predefined number of data channels in time-division of a first predefined number of cycles, wherein the first group of data includes at least three pieces of data, the first predefined number of data channels includes at least two data channels, the first predefined number of cycles includes at least two cycles, and a number of the plurality of performance control elements and a number of the pieces of data of the first group of data is larger than the first predefined number of data channels, and a first receiver that identifies the first group of data from data serially received from the first transmitter based on the identification information, wherein the first group of data includes information for driving the plurality of performance control elements.

According to an embodiment of the present disclosure, there is provided a musical device comprising a plurality of sensors that detect a movement of a plurality of performance control elements, respectively, the plurality of performance control elements including at least three performance control elements, a first transmitter that serially transmits identification information assigned by a first receiver to identify a first group of data and the first group of data, using a first predefined number of data channels in time-division of a first predefined number of cycles, wherein the first group of data includes at least three pieces of data, the first predefined number of data channels includes at least two data channels, the first predefined number of cycles includes at least two cycles, and a number of the plurality of performance control elements and a number of the pieces of data of the first group of data is larger than the first predefined number of data channels, and the first receiver that identifies the first group of data from data serially received from the first transmitter based on the identification information transmitted to the first transmitter, wherein the first group of data includes information indicating a detection result output from each of the plurality of sensors.

According to an embodiment of the present disclosure, there is provided a musical device comprising a plurality of driving units that drive a plurality of performance control elements, respectively, the plurality of performance control elements including at least three performance control elements, a first transmitter that serially transmits identification information assigned by a first receiver to identify a first group of data and the group of data, using a first predefined number of data channels in time-division of a first predefined number of cycles, wherein the first group of data includes at least three pieces of data, the first predefined number of data channels includes at least two data channels, the first predefined number of cycles includes at least two cycles, and a number of the plurality of performance control elements and a number of the pieces of data of the first group of data is larger than the first predefined number of data channels, and the first receiver that identifies the first group of data from data serially received from the first transmitter based on the identification information transmitted to the first transmitter, wherein the first group of data includes information for driving the plurality of performance control elements.

According to an embodiment of the present disclosure, there is provided a method of controlling a plurality of performance control elements by a plurality of sensors including a number of pieces of sensors (a is an integer of 3 or more, a>c) in a musical device. The plurality of sensors detects the movement of the plurality of performance control elements. The method comprises serially transmitting, by a first transmitter, identification information for identifying a group of data including b number of pieces of data (b is an integer of 3 or more, b>c) and the group of data in time division of p cycles (p is an integer of 2 or more) using c number of pieces of data channel (c is an integer of 2 or more), and identifying, by a first receiver, the group of data from data serially received from the first transmitter based on the identification information. The group of data includes information indicating a detection result output from the plurality of sensors, respectively.

According to an embodiment of the present disclosure, there is provided a method of controlling a plurality of performance control elements by a plurality of driving units including a number of pieces of driving units (a is an integer of 3 or more, a>c) in a musical device. The plurality of driving units drives and controls the plurality of performance control elements. The method comprises serially transmitting, by a first transmitter, identification information for identifying a group of data including b number of pieces of data (b is an integer of 3 or more, b>c) and the group of data in time division of p cycles (p is an integer of 2 or more) using c number of pieces of data channel (c is an integer of 2 or more), and identifying, by a first receiver, the group of data from data serially received from the first transmitter based on the identification information. The group of data includes information for driving the plurality of performance control elements.

According to an embodiment of the present disclosure, there is provided a method of controlling a plurality of performance control elements by a plurality of sensors including a number of pieces of sensors (a is an integer of 3 or more, a>c) in a musical device. The plurality of sensors detects the movement of the plurality of performance control elements. The method comprises serially transmitting, by a first transmitter, identification information assigned by a first receiver to identify a group of data including b numbers of pieces of data (b is an integer of 3 or more, b>c) and the group of data using c numbers of pieces of data channel (c is an integer of 2 or more) in time-division of p-cycle (p is an integer of 2 or more), and identifying, by the first receiver, the group of data from the data serially received from the first transmitter based on the identification information transmitted to the first transmitter. The group of data includes information indicating a detection result output from the plurality of sensors, respectively.

According to an embodiment of the present disclosure, there is provided a method of controlling a plurality of performance control elements by a plurality of driving units including a number of pieces of driving units (a is an integer of 3 or more, a>c) in a musical device. The plurality of driving units drives and controls the plurality of performance control elements. The method comprises serially transmitting, by a first transmitter, identification information assigned by a first receiver to identify a group of data including b numbers of pieces of data (b is an integer of 3 or more, b>c) and the group of data using c numbers of pieces of data channel (c is an integer of 2 or more) in time-division of p-cycle (p is an integer of 2 or more), and identifying, by the first receiver, the group of data from the data serially received from the first transmitter based on the identification information transmitted to the first transmitter. The group of data includes information for driving the plurality of performance control elements.

According to an embodiment of the present disclosure, there is provided a data transmission system including a first transmitter serially transmits identification information for identifying a group of data including b numbers of pieces of data (b is an integer of 3 or more, b>c) and the group of data using c numbers of pieces of data channel (c is an integer of 2 or more) in time-division of p-cycle (p is an integer of 2 or more), and a first receiver for identifying the group of data from the data serially received from the first transmitter based on the identification information.

According to an embodiment of the present disclosure, there is provided a data transmission system including a first transmitter serially transmits identification information assigned by a first receiver to identify a group of data including b numbers of pieces of data (b is an integer of 3 or more, b>c) and the group of data using c numbers of pieces of data channel (c is an integer of 2 or more) in time-division of p-cycle (p is an integer of 2 or more), and a first receiver for identifying the group of data from the data serially received from the first transmitter based on the identification information transmitted to the first transmitter.

According to an embodiment of the present disclosure, there is provided a data transmission system that includes serially transmitting, by a first transmitter, identification information for identifying a group of data including b numbers of pieces of data (b is an integer of 3 or more, b>c) and the group of data using c numbers of pieces of data channel (c is an integer of 2 or more) in time-division of p-cycle (p is an integer of 2 or more), and identifying, by a first receiver, the group of data from the data serially received from the first transmitter based on the identification information.

According to an embodiment of the present disclosure, there is provided a data transmission system that includes serially transmitting, by a first transmitter, identification information assigned by a first receiver to identify a group of data including b numbers of pieces of data (b is an integer of 3 or more, b>c) and the group of data using c numbers of pieces of data channel (c is an integer of 2 or more) in time-division of p-cycle (p is an integer of 2 or more), and identifying, by a first transmitter, the group of data from the data serially received from the first transmitter based on the identification information transmitted to the first transmitter.

### BRIEF DESCRIPTION OF DRAWINGS

FIG. 1 is an external view of an electronic keyboard device according to an embodiment of the present disclosure.

FIG. 2 is a block diagram showing a functional configuration of a musical device according to an embodiment of the present disclosure.

FIG. 3 is a block diagram showing a relationship between a sound source and each unit in a musical device according to an embodiment of the present disclosure.

FIG. 4 is a diagram showing an example of a configuration of a key sensor unit in a musical device according to an embodiment of the present disclosure.

FIG. 5 is a table showing an example of data transmitted and received between a first transmitter and a first receiver in a data transmission system according to an embodiment of the present disclosure.

FIG. 6 shows a data transmission flow in a data transmission system according to an embodiment of the present disclosure.

FIG. 7 shows a data transmission flow in a data transmission system according to an embodiment of the present disclosure.

FIG. 8 is a diagram showing an example of a configuration of a key driving unit in a musical device according to an embodiment of the present disclosure.

FIG. 9 is a table showing an example of data transmitted and received between a first transmitter and a first receiver in a data transmission system according to an embodiment of the present disclosure.

FIG. 10 is a block diagram showing a relationship between a control unit and each unit in a musical device according to an embodiment of the present disclosure.

FIG. 11 is a diagram showing an example of data transmitted and received between a control unit and each unit of a musical device according to an embodiment of the present disclosure.

### DESCRIPTION OF EMBODIMENTS

Hereinafter, embodiments of the present disclosure will be described with reference to the drawings and the like. However, the present disclosure can be implemented in many different aspects, and should not be construed as being limited to the description of the embodiments exemplified below.

The drawings may be schematically represented for clarity of explanation, but are merely examples, and do not limit the interpretation of the present disclosure. In addition, characters appended “first” and “second” to each element are terms used to distinguish each element, and do not have any further meaning unless otherwise specified. Furthermore, in the drawings referred to in the embodiments described below, the same or similar components having the same function are denoted by the same reference signs or similar reference signs (reference signs just adding A, B or 1, 2, or the like in the number XXX), and repeated explanation thereof may be omitted. In addition, a part of the configuration may be omitted from the drawings. Furthermore, in the case where a person ordinarily knowledge in the field to which the present disclosure pertains would recognize such matters, no special explanation will be provided.

According to the present disclosure, it is possible to provide a musical device capable of transmitting data in a multi-channel exceeding the number of channels defined by the communication by a TDM method in a time-division manner.

### First Embodiment

Hereinafter, a musical device according to the present embodiment will be described. For example, the musical device is an electronic keyboard device including a key and a pedal as a control element in the present embodiment. For example, the electronic keyboard device may be an automatic playing piano including a solenoid driving a key and a pedal, and a sound source.

### [Configuration of Musical Device]

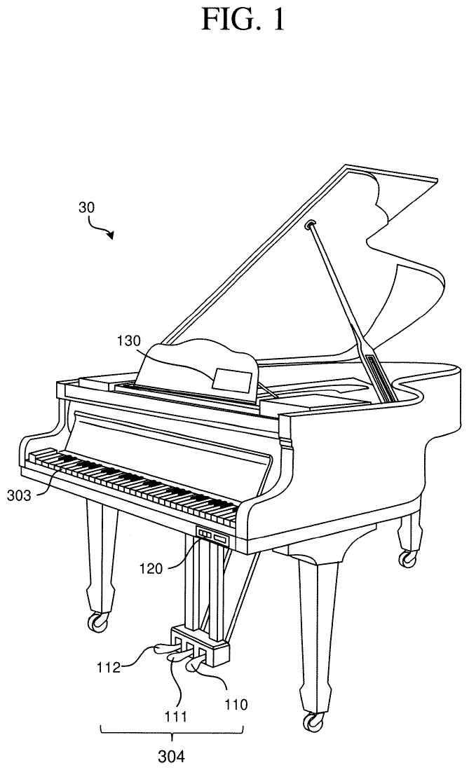

FIG. 1 is an external view of an electronic keyboard device 30 according to the present embodiment. Hereinafter, the electronic keyboard device 30 is referred to as a keyboard device 30. The keyboard device 30 is an automatic playing piano and includes a plurality of keys 303 and one or more pedals 304 (in the present embodiment, a loud pedal 110, a sostenuto pedal 111, and a soft pedal 112). In addition, the keyboard device 30 may include a disk drive 120 that reads performance information from a recording medium such as a DVD or a CD in which performance information in a MIDI (Musical Instrument Digital Interface) format is recorded. The keyboard device 30 may include a control panel 130 having a function of displaying various menu screens and the like for operating the keyboard device 30 and receiving an instruction from an operator on the side of a music stand.

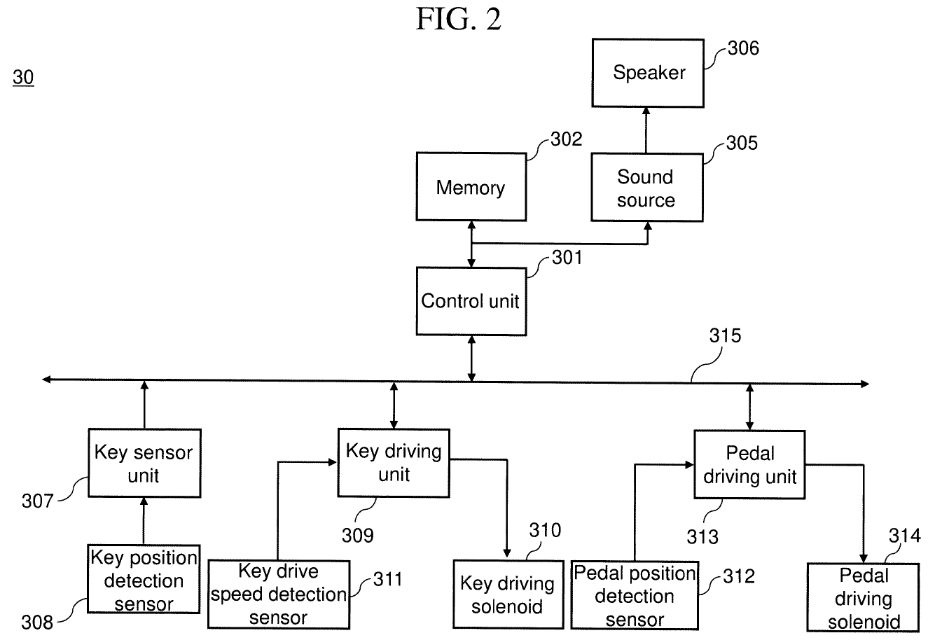

FIG. 2 is a diagram showing a functional configuration of the electronic keyboard device 30 according to the present embodiment. The keyboard device 30 includes a control unit 301, a memory 302, a sound source 305, a speaker 306, a key sensor unit 307, a key position detection sensor 308, a key driving unit 309, a key driving solenoid 310, a key drive speed detection sensor 311, a pedal position detection sensor 312, a pedal driving unit 313, and a pedal driving solenoid 314. The control unit 301, the key sensor unit 307, the key driving unit 309, and the pedal driving unit 313 are connected to each other via a bus 315.

The control unit 301 includes a CPU. The control unit 301 may include a RAM for temporarily storing data. The control unit 301 executes a control program stored in the memory 302 by the CPU, and controls each component of the keyboard device 30 to realize various functions. The functions to be realized include an automatic performance function. The control unit 301 includes a digital signal processor (DSP). The control unit 301 generates key driving information for driving the key 303 of the keyboard device 30 and pedal driving information for driving the pedal 304 based on performance information and outputs the generated key driving information and the pedal driving information to the key driving unit 309 and the pedal driving unit 313. The performance information will be described later.

The memory 302 is a storage device such as a non-volatile memory or a hard disk. The memory 302 stores a control program for realizing various functions in the keyboard device 30. The control program may be provided in a state of being stored in a computer-readable recording medium such as a magnetic recording medium, an optical recording medium, a magneto-optical recording medium, or a semiconductor memory. In this case, it is sufficient that the keyboard device 30 includes a device for reading the recording medium.

The keyboard device 30 includes the plurality of keys 303 as a control element. In addition, the keyboard device 30 includes one or more pedals 304 as the control element. The pedal 304 includes the loud pedal 110. Furthermore, the pedal 304 may include the sostenuto pedal 111 or the soft pedal 112.

The sound source 305 generates a sound signal based on a sound generation signal supplied via the bus 315, and supplies the generated sound signal to the speaker 306. The speaker 306 outputs a sound based on the received sound signal.

The key sensor unit 307 converts an analog key detection signal from the key position detection sensor 308 corresponding to each of the plurality of keys 303, which is the control element of the keyboard device 30, into a digital key detection signal and outputs the digital key detection signal to the control unit 301. Hereinafter, the key detection signal output to the control unit 301 is also simply referred to as a “detection result”. The key position detection sensor 308 is arranged corresponding to each key 303 of the keyboard device 30. The key position detection sensor 308 may be composed of a plurality of push-on pressure sensitive switches. Each switch detects the operation of the key 303 at different positions of the corresponding key 303. In addition, the key position detection sensor 308 may be an optical sensor (key sensor). The optical sensor can contiguously detect a series of movements from the start of the depression of the key 303 to the return to a rest position. The key detection signal output from the key position detection sensor 308 is used to calculate a key depression speed and a key depression acceleration.

The key driving unit 309 outputs a key driving signal for driving the key 303 of the keyboard device 30 based on the key driving information. The key driving unit 309 outputs the key driving signal to the key driving solenoid 310 corresponding to each key 303 of the keyboard device 30. The key driving solenoid 310 displaces a plunger based on the driving signal to drive each key 303.

The pedal position detection sensor 312 detects a position of the pedal, which is the control element of the keyboard device 30. The pedal may be the loud pedal 110 of the keyboard device 30. The pedal detection signal output from the pedal position detection sensor 312 can be used to calculate a position of the loud pedal 110, that is, a depression depth of the loud pedal 110.

The pedal driving unit 313 outputs a pedal driving signal for driving the pedal 304 of the keyboard device 30 based on the pedal driving information. The pedal driving unit 313 outputs the pedal driving signal to the pedal driving solenoid 314 that drives the pedal 304 of the keyboard device 30. The pedal driving solenoid 314 displaces the plunger based on the pedal driving signal. The pedal driving unit 313 converts an analog pedal detection signal from the pedal position detection sensor 312 into a digital pedal detection signal and outputs the digital pedal detection signal to the control unit 301.

The performance information is the performance information in the MIDI format, and may be stored in the memory 302 in advance. In addition, the keyboard device 30 may include a disk drive (not shown). In this case, the control unit 301 may read the performance information stored in the disc drive to generate the key driving information and the pedal driving information. In addition, the keyboard device 30 may include a communication I/F (not shown), and the performance information may be externally supplied via the communication I/F. The performance information includes sound control data and pedal control data. The sound control data is event data (note-on, note-off, and the like) for a keyboard, which defines the generation and stop of a sound. The pedal control data is event data for a pedal that defines the depression depth and timing of the loud pedal 110.

In the automatic performance by the keyboard device 30, the DSP of the control unit 301 generates the key driving information and the pedal driving information, which are the digital signal for operating the key 303 and the pedal 304 of the keyboard device 30, based on the performance information, and outputs the generated key driving information and the pedal driving information to the key driving unit 309 and the pedal driving unit 313, respectively. The key driving unit 309 supplies the key driving information to the key driving solenoid 310. The pedal driving unit 313 converts the input pedal driving information into an analog signal. Furthermore, the pedal driving unit 313 converts the analog signal into a PWM signal and supplies it to the pedal driving solenoid 314. The PWM signal is a signal obtained by pulse-width-modulating the analog signal so as to have a duty ratio corresponding to a target current supplied to the pedal driving solenoid 314 for driving the pedal.

A digitized key drive speed signal may be supplied to the DSP of the control unit 301 from the key drive speed detection sensor 311 that detects the drive of the key driving solenoid 310 via the key driving unit 309. The key drive speed signal is a signal indicating the speed of the key 303 driven by the key driving solenoid 310. The key drive speed detection sensor 311 may include a speed sensor arranged in the key driving solenoid 310 and configured to detect a movement speed of the plunger. Similarly, a digitized pedal position signal may be supplied to the DSP of the control unit 301 from the pedal position detection sensor 312 via the pedal driving unit 313. The pedal position signal is a signal indicating a position of the pedal 304, that is, the depression depth of the pedal 304 driven by the pedal driving solenoid 314. In this case, a sensor for detecting the amount of movement of the plunger may be arranged in the pedal driving solenoid 314. The control unit 301 may use the key drive speed signal and the pedal position signal for a feedback drive control of the key 303 and the pedal 304.

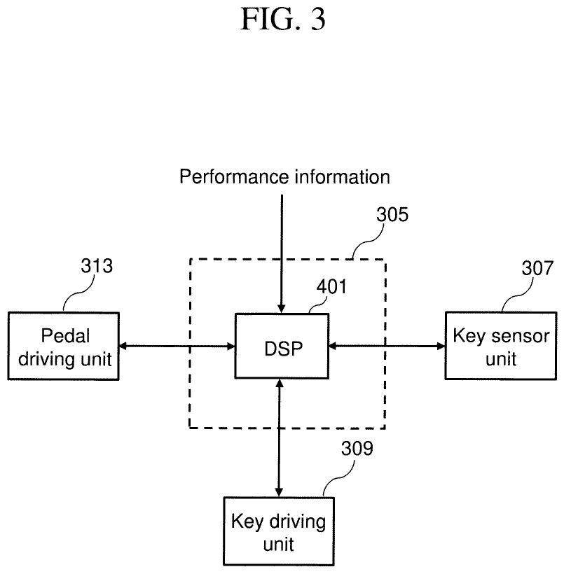

FIG. 3 is a block diagram showing a relationship between a DSP 401 of the control unit 301 and the key sensor unit 307, the key driving unit 309, and the pedal driving unit 313 in the present embodiment. As described above, the DSP 401 of the control unit 301 receives the key detection signal from the key sensor unit 307. The DSP 401 outputs the key driving information for driving the key to the key driving unit 309. The DSP 401 may receive the key drive speed signal from the key drive speed detection sensor 311 via the key driving unit 309. The DSP 401 outputs the pedal driving signal for driving the pedal to the pedal driving unit 313. The DSP 401 may receive the pedal position signal from the pedal position detection sensor 312 via the pedal driving unit 313. The DSP 401 generates the key driving information and the pedal driving information based on the performance information read from the memory 302 or the disk drive.

The DSP 401 of the control unit 301 shown in FIG. 3 and the key sensor unit 307, the key driving unit 309, and the pedal driving unit 313 transmit and receive data using the TDM method each other. In particular, in the case where the number of keys 303 of the keyboard device 30 is 88 keys, which is the same as that of a full-size piano, the number of channels exceeding 32 channels defined by communication according to the common TDM method is required to transmit and receive the key detection signal, the key driving information, and the key drive speed signal between the DSP 401 and the key sensor unit 307 or the key driving unit 309. Therefore, in the present embodiment, a group of data including the number of channels exceeding 32 channels is transmitted and received by using a data transmission system that transmits and receives an audio signal. In addition, the number of keys 303 of the keyboard device 30 is a (a is an integer of 3 or more), and a>c. c is the number of data channels used to transmit and receive data, and is an integer of 2 or more.

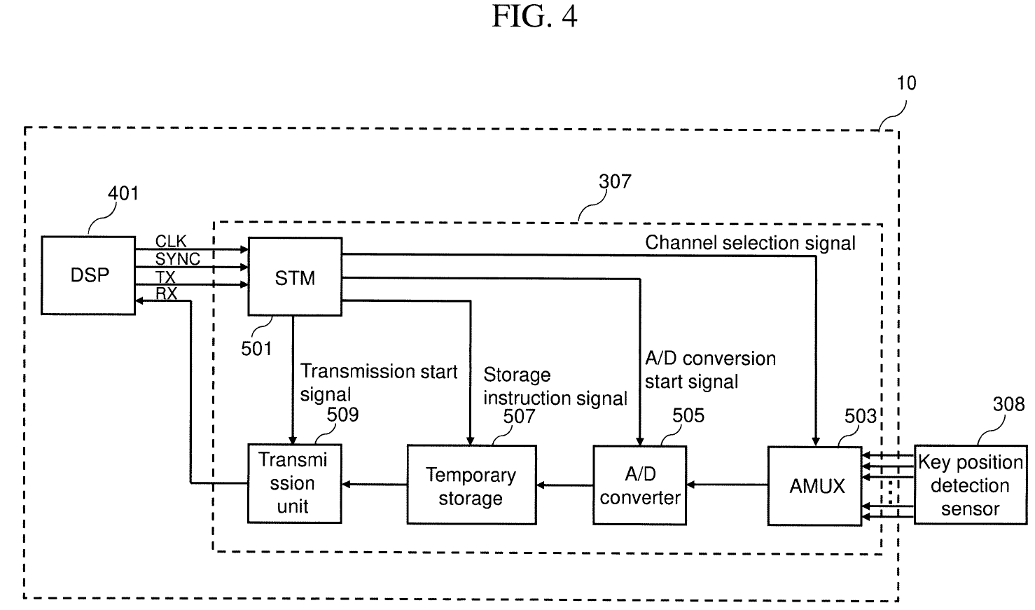

FIG. 4 is a diagram showing an example of a configuration of the key sensor unit 307. The key sensor unit 307 transmits and receives data to and from the DSP 401. The DSP 401 and the key sensor unit 307 constitute a data transmission system 10 according to an embodiment of the present disclosure. In the data transmission system 10 shown in FIG. 3, the DSP 401 is a receiver (first receiver) that receives the detection result from the key sensor unit 307. On the other hand, in the data transmission system 10, the key sensor unit 307 is a transmitter (first transmitter) that transmits the detection result to the DSP 401.

The DSP 401 transmits a clock signal CLK, a synchronized signal SYNC, and a transmission signal TX to the key sensor unit 307. The transmission signal TX includes identification information for identifying a group of data (a first group of data) including b number of pieces of data (b is an integer of 3 or more, and b>c) transmitted from the key sensor unit 307 to the DSP 401. That is, the DSP 401 assigns, to the key sensor unit 307, the identification information for identifying a group of data transmitted from the key sensor unit 307 to the DSP 401. The DSP 401 may serially transmit the transmission signal TX, that is, a group of data including the identification information, using c number of pieces of data channel (c is an integer of 2 or more) in time-division of p cycles (p is an integer of 2 or more).

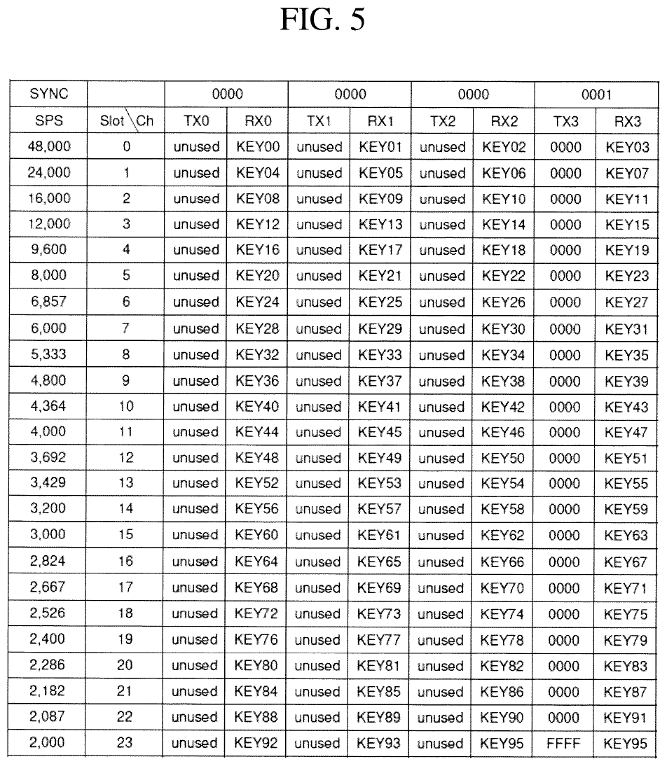

For example, the DSP 401 may transmit a group of data for 96 channels including the identification information to the key sensor unit 307 using 4 channels in time-division of 24 cycles. FIG. 5 is a table showing an example of the transmission signal TX transmitted from the DSP 401 to the key sensor unit 307 and a received signal RX supplied to the DSP 401 from the key sensor unit 307. The DSP 401 may transmit a group of data for 96 channels to the key sensor unit 307 in 24 slots (0 to 23 slots) using 4 channels TX0, TX1, TX2, and TX3. In the case where the number of keys 303 of the keyboard device 30 is 88, KEY00 to KEY87 of the received signal RX are data indicating the key detection signal (detection result) of the 88 keys at timings every 2 kHz (SPS: 2,000). The remaining KEY88 to KEY95 may be dummy data.

As shown in FIG. 5, the synchronized signal SYNC is output from the DSP 401 in synchronization with the separation of one slot (one time slot) based on the clock signal CLK. As a result, the key sensor unit 307 can identify the four channels (TX0 to TX3) of one slot. The synchronized signal SYNC may be output using one channel used for data communication. In the example shown in FIG. 5, the synchronized signal SYNC is output in one channel TX3 out of the four channels TX0, TX1, TX2, and TX3.

As described above, a group of data for 96 channels includes identification information for identifying a group of data transmitted to the DSP 401 from the key sensor unit 307. In the example shown in FIG. 5, at the end of the group of data for 96 channels transmitted from the DSP 401 to the key sensor unit 307, identification information FFFF for specifying the group of data is included. Although details will be described later, the key sensor unit 307 transmits a group of data including b number of pieces of data to the DSP 401 based on the received identification information FFFF.

The identification information is distinguished from a group of data excluding the identification information in the data transmitted from the DSP 401. Therefore, the value of the group of data is a range of values excluding the identification information. For example, as shown in FIG. 5, in the case where the identification information is FFFF, the group of data transmitted from the DSP 401 may be 0000 to FFFE. The identification information is not limited to FFFF as long as it can be distinguished from the group of data.

Although the case where the identification information FFFF for specifying the group is transmitted from the key sensor unit 307 at the end of the group of data for 96 channels is shown as an example in FIG. 5, the timing at which the key sensor unit 307 transmits the identification information is not limited to the end of the group of data.

As shown in FIG. 4, the key sensor unit 307 includes a state machine (STM) 501, an analog multiplexer (AMUX) 503, an analog/digital converter (A/D converter) 505, a temporary storage 507, and a transmission unit 509.

The state machine (STM) 501 receives the clocking signal CLK, the synchronized signal SYNC, and the transmission signal TX from the DSP 401. The state machine 501 includes a counter for measuring the number of pulses in the clock signal CLK, a register for temporarily storing received data, and the like. The state machine 501 identifies the identification information included in the transmission signal TX transmitted from the DSP 401. Specifically, the state machine 501 may identify the identification information included in the transmission signal TX received from the DSP 401 based on the measurement result by the counter, that is, the number of pulses in the clock signal CLK measured by the counter. In addition, the state machine 501 can identify the data of four channels (TX0 to TX3) of one slot based on the measurement result by the counter and the synchronized signal SYNC.

The state machine 501 may output a channel selection signal to the AMUX 503 in synchronization with the clock signal CLK and/or the synchronized signal SYNC received from the DSP 401, output an analog-to-digital (A/D) conversion start signal to the A/D converter 505, output a storage instruction signal to the temporary storage 507, and output a transmission start signal to the transmission unit 509.

The AMUX 503 receives the analog key detection signal from the key position sensor 308. The AMUX 503 may be a 96-channel multiplexer. The AMUX 503 receives the channel selection signal from the state machine 501. The channel selection signal is a signal for indicating the channel to be selected by the AMUX 503. The AMUX 503 receives the key detection signal of the selected channel from the 96 channels based on the channel selection signal, and outputs the received key detection signal to the A/D converter 505.

The A/D converter 505 receives the analog key detection signal from the AMUX 503. The A/D converter 505 digitizes the received analog key detection signal based on an A/D conversion start signal received from the state machine 501. The A/D converter 505 outputs the digital key detection signal to the temporary storage 507.

The temporary storage 507 temporarily stores the digital key detection signal received from the A/D converter 505. The temporary storage 507 may be a latch circuit. The temporary storage 507 temporarily stores the key detection signal based on the storage instruction signal received from the state machine 501.

The transmission unit 509 receives the transmission start signal from the state machine 501. The transmission unit 509 reads the key detection signal from the temporary storage 507 based on the received transmission start signal and the identification information assigned by the DSP 401, and outputs the read key detection signal to the DSP 401 serially. For example, the transmission unit 509 may be a 4-channel TDM interface in the present embodiment.

The transmission unit 509 serially transmits the key detection signal to the DSP 401 in p-cycle time division using c number of pieces of data channel as the group of data including b number of pieces of data. For example, the transmission unit 509 may serially output the 96 channels of data including the key detection signal to the DSP 401 as a group of data. In the present embodiment, the transmission unit 509 divides the group of 96 channels of data based on the identification information assigned by the DSP 401 and the measurement result by the counter, and transmits the data to the DSP 401 using 4 channels in time-division of 24 cycles. The group of data transmitted to the DSP 401 from the transmission unit 509 may include the identification information assigned by the DSP 401.

The DSP 401 serially receives the group of data for 96 channels from the key sensor unit 307 as the received signal RX. The DSP 401 can determine the separation of the group of data received from the transmission unit 509 of the key sensor unit 307 based on the assigned identification information, and can identify the group of data.

For example, in the example shown in FIG. 5, KEY95 is data corresponding to the identification information. The DSP 401 can determine KEY95 of the group of data received from the key sensor unit 307 as separation of the group of data, and can identify the group of data received from the key sensor unit 307.

The number of channels defined by the communication according to the common TDM method is up to 32 channels. Therefore, in order to transmit data of the number of channels exceeding 32 channels, it is necessary to prepare a dedicated interface. In the present embodiment, one of the channels used for data communication is used as a channel for identifying one slot. The group of data of the number of channels exceeding 32 channels includes the identification information for identifying the group of data, so that the receiver can identify the received group of data. Therefore, according to the present embodiment, it is possible to transmit multi-channel data exceeding the number of channels defined by the communication according to the common TDM method in a time-division manner by using a commonly used TDM interface without using the dedicated TDM interface.

In addition, the value that the group of data for 96 channels transmitted from the key sensor unit 307 to the DSP 401 can take includes the value of the identification information assigned by the DSP 401.

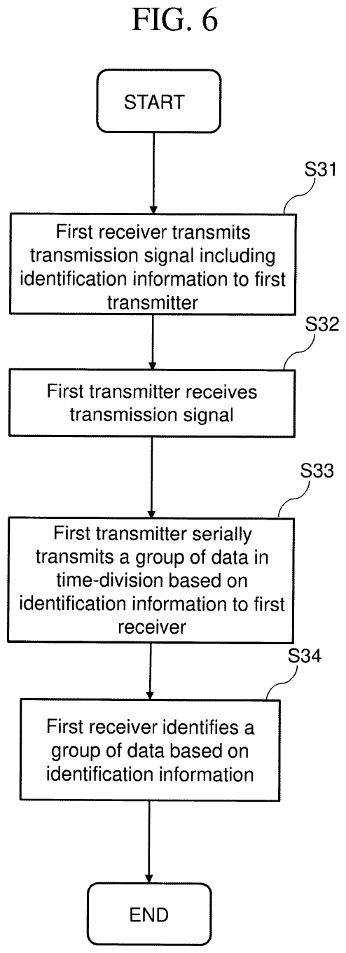

FIG. 6 shows an example of a data transmission flow in the data transmission system 10 according to the present embodiment. As shown in FIG. 6, when data communication is started, the DSP 401 (first receiver) transmits a transmission signal including the identification information to the key sensor unit 307 (first transmitter) (S31). As described above, the identification information is information for identifying a group of data transmitted from the key sensor unit 307 to the DSP 401.

The key sensor unit 307 receives the transmission signal transmitted from the DSP 401 (S32). The key sensor unit 307 divides a group of data based on the identification information included in the received transmission signal, and serially transmits the group of data to the DSP 401 in a time-division manner with a predetermined number of channels and a predetermined slot (S33).

The DSP 401 serially receives the group of data from the key sensor unit 307. The DSP 401 determines the separation of the group of data transmitted from the key sensor unit 307 based on the identification information which had transmitted to the key sensor unit 307 in advance, and identifies the group of data (S34).

Although the identification information for identifying a group of data is assigned by the DSP 401 (first receiver) to the key sensor unit 307 (first transmitter) in the above explanation, the present embodiment is not limited to this. The DSP 401 does not have to assign the identification information for identifying a group of data transmitted from the key sensor unit 307.

In this case, the key sensor unit 307 (first transmitter) transmits a group of data including b number of pieces of data including identification information for identifying the group of data to the DSP 401 (first receiver). This identification information is not assigned by the DSP 401. For example, the identification information may be FFFF. The key sensor unit 307 transmits a group of data for 96 channels including FFFF as the identification information for identifying the group of data to the DSP 401.

The key sensor unit 307 serially transmits the group of data for 96 channels including FFFF, which is the value of the identification information, to the DSP 401 in a time-division manner. For example, the key sensor unit 307 may transmit the group of data for 96 channels to the DSP 401 using 4 channels in time-division of 24 cycles. The identification information is distinguished from the group of data excluding the identification information in the data transmitted from the key sensor unit 307. Therefore, the value of the group of data is a range of values excluding the identification information. For example, in the case where the identification information is FFFF, the value that a group of data can take is 0000 to FFFE excluding FFFF, which is the value of the identification information.

As described above, in the case where the identification information for identifying a group of data output from the key sensor unit 307 is not assigned by the DSP 401, the identification information FFFF may be entered in place of KEY95 in RX3 of the 23 slots of the four channels in FIG. 5.

The DSP 401 can identify the group of data based on the identification information FFFF included in the group of data for 96 channels received from the key sensor unit 307.

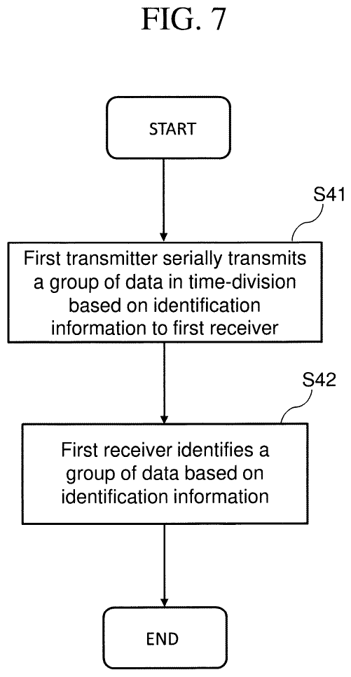

FIG. 7 shows another example of a data transmission flow in the data transmission system 10 according to the present embodiment. Unlike FIG. 6, FIG. 7 shows a data transmission flow in the case where the identification data is not assigned by the DSP 401. As shown in FIG. 7, when data communication is started, the key sensor unit 307 (first transmitter) serially transmits a group of data including the identification information to the DSP 401 (first receiver) in a time-division manner in a predetermined number of channels and a predetermined slot (S41). As described above, the identification information is information for identifying the group of data transmitted from the key sensor unit 307 (first transmitter) to the DSP 401 (first receiver).

The DSP 401 serially receives the group of data from the key sensor unit 307. The DSP 401 determines the separation of the group of data transmitted from the key sensor unit 307 based on the identification information included in the group of data received from the key sensor unit 307, and identifies the group of data (S42).

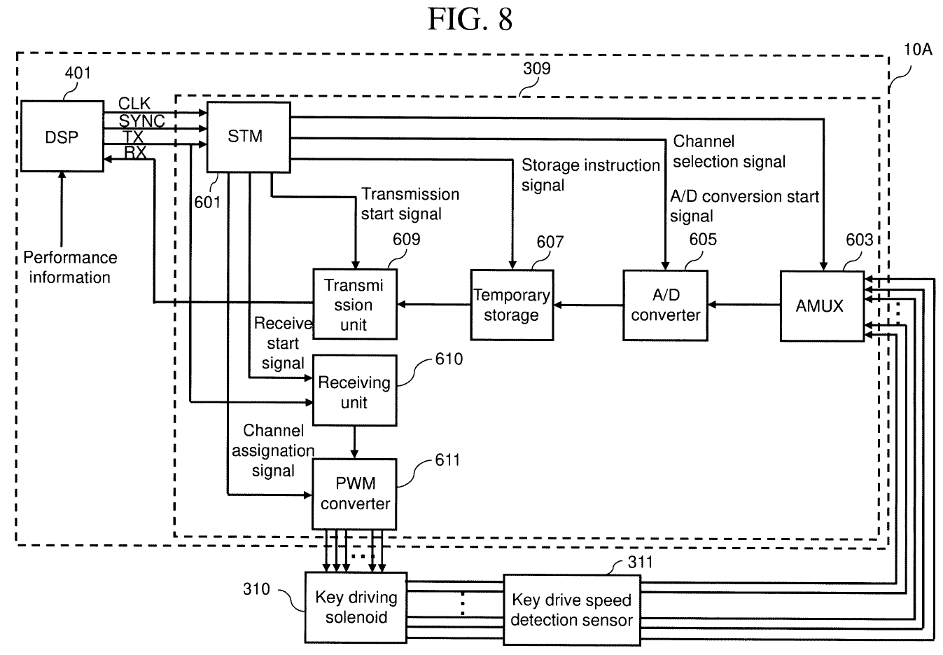

FIG. 8 is a diagram showing an example of a configuration of the key driving unit 309. The key driving unit 309 transmits and receives data to and from the DSP 401. The DSP 401 and the key driving unit 309 constitute a data transmission system 10A according to an embodiment of the present disclosure. In the data transmission system 10A shown in FIG. 8, the DSP 401 is a transmitter (first transmitter) that transmits information for driving the key 303 to the key driving unit 309. On the other hand, the key driving unit 309 is a receiver (first receiver) that receives the information for driving the key 303 from the DSP 401.

The DSP 401 obtains the performance information. The DSP 401 generates key driving information for driving the key 303 of the keyboard device 30 based on the performance information. The DSP 401 transmits the key driving information together with the clock signal CLK and the synchronized signal SYNC to the key driving unit 309 as the transmission signal TX. The transmission signal TX includes the identification information for identifying a group of data including b number of pieces of data transmitted from the DSP 401 to the key driving unit 309. That is, in the present embodiment, the DSP 401 transmits the group of data including the identification information to the key driving unit 309.

As shown in FIG. 8, the key driving unit 309 includes a state machine (STM) 601, an analog multiplexer (AMUX) 603, an analog/digital converter (A/D converter) 605, a temporary storage 607, a transmission unit 609, a receiving unit 610, and a PWM converter 611.

The state machine (STM) 601 receives the clock signal CLK, the synchronized signal SYNC, and the transmission signal TX from the DSP 401. The state machine 601 includes a counter for measuring the number of pulses in the clock signal CLK, a register for temporarily storing received data, and the like. The state machine 601 identifies the identification information transmitted from the DSP 401. Specifically, the state machine 601 may identify the identification information included in the transmission signal TX received from the DSP 401 based on the measurement result by the counter, that is, the number of pulses in the clock signal CLK measured by the counter.

The state machine 601 may output a channel selection signal to the AMUX 603 in synchronization with the clock signal CLK and/or the synchronized signal SYNC received from the DSP 401, output an analog-to-digital (A/D) conversion start signal to the A/D converter 605, output a storage instruction signal to the temporary storage 607, output a transmission start signal to the transmission unit 609, and output a channel assignation signal to the DEMUX 611.

The AMUX 603 may receive an analog key drive speed signal output from the key drive speed detection sensor 311. The AMUX 603 may be a 96-channel multiplexer. The AMUX 603 receives the channel selection signal from the state machine 601. The channel selection signal is a signal for indicating the channel to be selected by the AMUX 603. The AMUX 603 receives the analog key drive speed signal of the selected channel from the 96 channels based on the channel selection signal, and outputs the received analog key drive speed signal to the A/D converter 605.

The A/D converter 605 receives the analog key drive speed signal from the AMUX 603. The A/D converter 605 digitizes the received analog key drive speed signal based on the A/D conversion start signal received from the state machine 601. The A/D converter 605 outputs the digital key drive speed signal to the temporary storage 607.

The temporary storage 607 temporarily stores the digital key drive speed signal received from the A/D converter 605. The temporary storage 607 may be a buffer or a latch circuit. The temporary storage 607 temporarily stores the key drive speed signal based on the storage instruction signal received from the state machine 601.

The transmission unit 609 receives the transmission start signal from the state machine 601. The transmission unit 609 reads the key drive speed signal from the temporary storage 607 based on the received transmission start signal and the identification information assigned by the DSP 401, and outputs the read key drive speed signal to the DSP 401 serially. For example, the transmission unit 609 may be a 16-channel TDM interface in the present embodiment.

The transmission unit 609 serially transmits the key drive speed signal to the DSP 401 in a p-cycle time division using c number of pieces of data channel as a group of data including b number of pieces of data. For example, the transmission unit 609 may serially output data of 96 channels including the key drive speed signal to the DSP 401 as the group of data. The transmission unit 609 divides the group of 96 channels of data based on the identification information assigned by the DSP 401 and the measurement result by the counter, and transmits the data to the DSP 401 using 16 channels in time-division of 8 cycles.

The DSP 401 can determine the separation of the group of data received serially from the transmission unit 609 of the key driving unit 309 and identify the group of data based on the identification information included in the transmission signal (TX) transmitted to the key driving unit 309. According to the present embodiment, the DSP 401 can feedback-control the driving of the key 303 of the keyboard device 30 in real time based on the key drive speed signal included in the group of data.

The receiving unit 610 receives the transmission signal TX from the DSP 401 based on a receive start signal received from the state machine 601. The receiving unit 610 converts the key driving information included in the transmission signal TX into an analog signal, and outputs the analog signal to the PWM converter 611.

The PWM converter 611 generates the key driving signal by pulse-width-modulating the key driving information received from the receiving unit 610 so as to have a duty ratio corresponding to a target current supplied to the key driving solenoid 310 for driving the key 303. The PWM converter receives a channel assignation signal from the state machine 601. The channel assignation signal is a signal for assigning a channel to which the key driving signal is output. The PWM converter 611 distributes the key driving signal to the assigned channel among the plurality of channels based on the channel assignation signal, and outputs the key driving signal to the key driving solenoid 310 via the assigned channel. For example, the PWM converter 611 may have 96 channels.

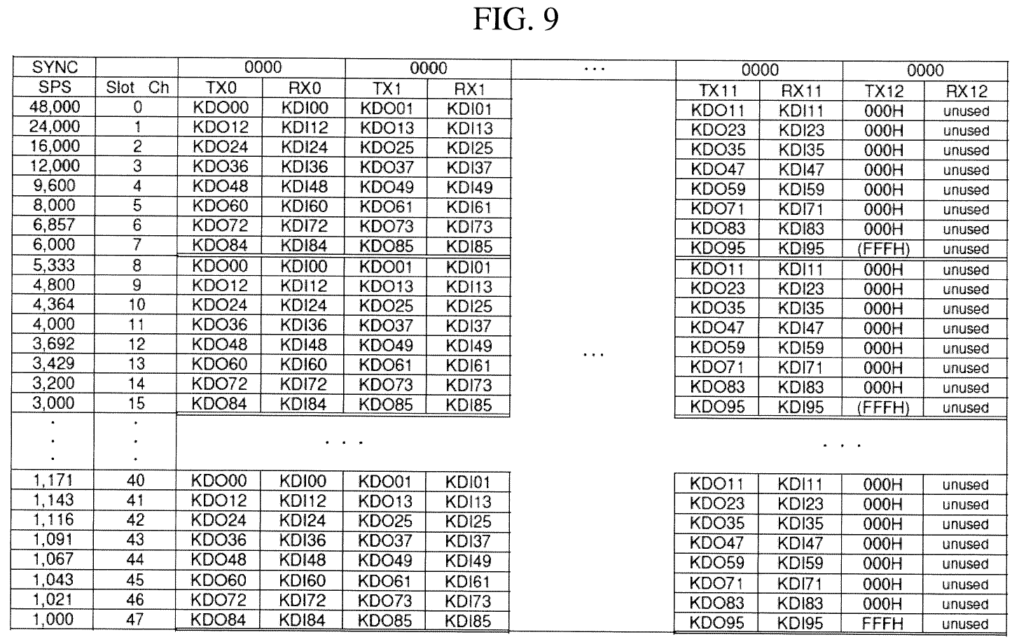

FIG. 9 is a table showing an example of the transmission signal TX transmitted from the DSP 401 to the key driving unit 309 and the received signal RX supplied to the DSP 401 from the key driving unit 309. The transmission signal TX includes a key driving information KDO. The received signal RX includes a key drive speed signal KDI. The DSP 401 may transmit a group of data for 96 channels to the key driving unit 309 in 8 cycles using 16 channels. FIG. 9 shows data for 48 slots (0 to 47 slots) transmitted and received between the DSP 401 and the key driving unit 309. In the case where the number of keys 303 of the keyboard device 30 is 88, KDO00 to KDO87 of the transmission signal TX are data indicating the key driving information of the 88 keys at timings every 6 kHz (SPS: 6,000). KDI00 to KDI87 of the received signal RX are data indicating the key drive speed signal of the 88 keys at timings every 6 kHz (SPS: 6,000). The remaining KDO88 to KDO95 and KDI88 to KDI95 may be dummy data. The key driving information KDO and the key drive speed signal KDI are transmitted and received using 12 channels. The channel 13 is used to transmit and receive identification information for identifying a group of data. The remaining 14 to 16 channels (not shown) may contain dummy data.

As described above, the group of data for 96 channels may include the identification information for identifying the group of data transmitted from the DSP 401 to the key driving unit 309. In the example shown in FIG. 9, at the end of six sets of a group of data transmitted from the DSP 401 to the key driving unit 309, identification information FFFH is included to identify the group of data. The identification information is not limited to FFFH as long as it can be distinguished from a group of data.

As shown in FIG. 9, the identification information FFFH for identifying a group of data may be transmitted from the DSP 401 every 6 kHz (SPS: 6,000) as well as at the end of the six sets of the group of data. In other words, the identification information FFFH for identifying the group of data may be included for each of the six sets of the group of data. In addition, the timing at which the DSP 401 transmits the identification information is not limited to the end of a group of data.

According to the present embodiment, even if the number of keys of the keyboard device 30 is 88 keys, which is the same as that of a full-size piano, the information (KDI) of the speed at which the keys move and the information (KDO) for driving the keys can be simultaneously transmitted and received as a group of data of the number of channels exceeding 32 channels defined by communication according to the common TDM method.

Although illustration and explanation are omitted, the configuration of the first receiver or the first transmitter of the above-described data transmission systems 10 and 10A may be applied to the DSP 401 and the pedal driving unit 313.

The case where the DSP 401, the transmission unit 509 of the key sensor unit 307, and the transmission unit 609 of the key driving unit 309 divide a group data for 96 channels and transmit the data in a time-division manner by using a plurality of channels has been escribed in the above description. However, the size of a group of data, the number of channels used for data transmission, and the number of time-division cycles (the number of slots) of data are not limited to the above-described embodiments.

For example, the data transmission system may include a first transmitter that transmits a first group of data including b number of pieces of data (b is an integer of 3 or more, b>c), and a second transmitter that transmits a second group of data including d number of pieces of data (d is an integer of 3 or more, d>e), which is different from the first group of data in data size. In this case, e #c may be satisfied. In addition, the first transmitter may transmit the first group of data including b number of pieces of data in time-division of p cycles using c number of pieces of data channel, and the second transmitter may transmit the second group of data including d pieces of data in time-division of q cycles (q is an integer of 2 or more) using e pieces of data channels (e is an integer of 2 or more). In this case, q #p may be satisfied.

As described above, in the case where the data transmission system includes a plurality of transmitter, the number of channels used for data transmission and/or the number of time-division cycles (the number of slots) of data may be different for each transmitter. As a result, data communication can be performed more efficiently.

### Second Embodiment

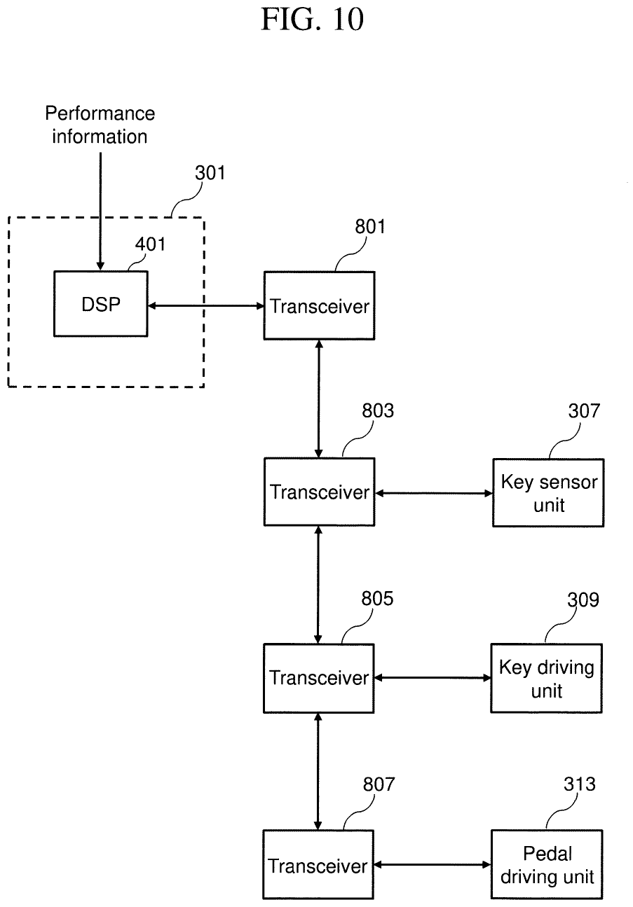

FIG. 10 is a block diagram showing a relationship between the DSP 401 of the control unit 301 and the key sensor unit 307, the key driving unit 309, and the pedal driving unit 313 according to another embodiment of the present disclosure. In the present embodiment, the DSP 401 is connected to the key sensor unit 307, the key driving unit 309, and the pedal driving unit 313 via a plurality of serially connected transceivers 801, 803, 805, and 807.

The transceivers 801, 803, 805, and 807 mediate data communication between the DSP 401, the key sensor unit 307, the key driving unit 309, and the pedal driving unit 313 and the bus 315. Data may be transmitted and received between the key sensor unit 307 and the transceiver 803 by TDM4. Data may be transmitted and received between the key driving unit 309 and the transceiver 805 by TDM16. Data may be transmitted and received between the pedal driving unit 313 and the transceiver 807 by TDM2. Data may be transmitted and received between the DSP 401 and the transceiver 801 by TDM32.

Between the transceivers 801, 803, 805 and 807, data in the audio-signal format of 48 KHz sampling frequency is assigned to 32 channels. The first transmitter or the first receiver of the above-described data transmission systems 10 and 10A is applied to the transceivers 801, 803, 805, and 807, the DSP 401, the key sensor unit 307, the key driving unit 309, and the pedal driving unit 313. The clock signal may be changed as appropriate depending on the amount of data to be transmitted and received.

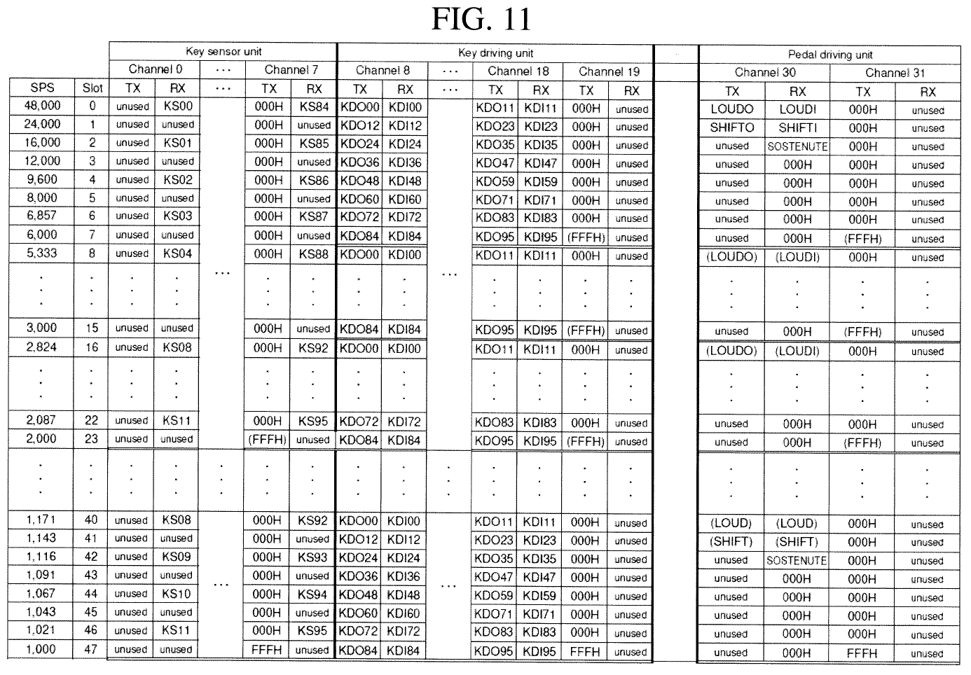

FIG. 11 is a table showing an example of data transmitted and received between the DSP 401 and the key sensor unit 307, the key driving unit 309, and the pedal driving unit 313 in the musical device having the relationship shown in FIG. 10. Data for 8 channels (Channel 0 to Channel 7) in FIG. 11 is transmitted and received between the key sensor unit 307 and the transceiver 801. Similarly, data for 12 channels (Channel 8 to Channel 19) in FIG. 11 is transmitted and received between the key driving unit 309 and the transceiver 805, and data for 2 channels (Channel 30 to Channel 31) in FIG. 11 is transmitted and received between the pedal driving unit 313 and the transceiver 807.

Data for 2 channels (Channel 30 to Channel 31) is transmitted and received between the transceiver 805 and the transceiver 807. Channel 30 and Channel 31 are used to transmit and receive data between the DSP 401 and the pedal driving unit 313. LOUDO of the transmission signal TX is data indicating the pedal driving information of the loud pedal 110 at timings every 6 kHz (SPS: 6,000). The pedal driving information is information for driving a pedal, which is output from the DSP 401 to the pedal driving unit 313. On the other hand, LOUDI of the received signal RX is data indicating the pedal detection signal of the loud pedal 110, which is output from the pedal position detection sensor 312 via the pedal driving unit 313. Similarly, SHIFTO of the transmission signal TX is data indicating the pedal driving information of the soft pedal 112 at timings every 6 kHz (SPS: 6,000), and SHIFTI of the received signal RX is data indicating the pedal detection signal of the soft pedal 112. The identification information FFFH for identifying a group of data may be transmitted from the DSP 401 at timings every 6 kHz (SPS: 6,000).

In FIG. 11, the data in “( )” may be omitted. That is, the identification information FFFH for identifying a group of data may be transmitted from the DSP 401 at timings of every 1 kHz (SPS: 1,000). In addition, the pedal drive information (LOUDO, SHIFTO) and the pedal detection signal (LOUDI, SHIFTI) may be transmitted and received at timings every 6 kHz, or may be transmitted and received at timings every 1 kHz (SPS: 1,000). However, if the sampling rate is large, the pedal driving accuracy and the pedal detection accuracy can be improved.

Data for 14 channels (Channel 30 to Channel 31 and Channel 8 to Channel 19) is transmitted and received between the transceiver 805 and the transceiver 803. Channel 8 to Channel 19 are used to transmit and receive data between the DSP 401 and the key driving unit 309. KDO00 to KDO87 of the transmission signal TX are data indicating the key driving information of 88 keys at timings 6 kHz (SPS: 6,000). KDI00 to KDI87 of the received signal RX are data indicating the key drive speed signal of 88 keys at timings every 6 kHz (SPS: 6,000). KDO88 to KDO95, and KDI88 to KDI95 may be dummy data. The identification information FFFH for identifying a group of data may be transmitted from the DSP 401 at timings every 6 kHz (SPS: 6,000). However, the data in “( )” in FIG. 11 may be omitted, and the identification information FFFH for identifying a group of data may be transmitted from the DSP 401 at timings every 1 kHz (SPS: 1,000).

Data for 22 channels (Channel 30 to Channel 31, Channel 8 to Channel 19, and Channel 0 to Channel 7) is transmitted and received between the transceiver 803 and the transceiver 801. Channel 0 to Channel 7 are used to transmit and receive data between the DSP 401 and the key sensor unit 307. Unlike the example shown in FIG. 5, a group of data transmitted/received between the DSP 401 and the key sensor unit 307 is transmitted and received in 24 slots (0 to 23 slots) using 8 channels (Channel 0 to Channel 7). KS00 to KS87 of the received signal RX are data indicating the key detection signal (detection result) of 88 keys at timings every 2 kHz (SPS: 2,000). KS88 to KS95 may be dummy data. The identification information FFFH for identifying a group of data may be transmitted from the DSP 401 at timings every 2 kHz (SPS: 2,000). However, the data in “( )” in FIG. 11 may be omitted, and the identification information FFFH for identifying a group of data may be transmitted from the DSP 401 at timings every 1 kHz (SPS: 1,000).

Data for 32 channels including data for 22 channels (Channel 30 to Channel 31, Channel 8 to Channel 19, and Channel 0 to Channel 7) may be transmitted and received between the transceiver 801 and the DSP 401. In addition, Channel 20 to Channel 29 not shown in FIG. 11 may not include data, that is, “unused”. Furthermore, Channel 20 to Channel 29 may be assigned as channels, not shown, for transmitting and receiving data between the driving unit for driving the performance control element of the musical device 30 or a detecting unit for detecting the movement of the performance control element and the DSP 401.

In FIG. 11, the identification information for identifying a group of data is indicated by the FFFH. The DSP 401 and the transceivers 801, 803, 805, and 807 can identify the group of data by the identification information FFFH included in the group of data. As shown in FIG. 11, a group of data transmitted and received by the key sensor unit 307, the key driving unit 309, and the pedal driving unit 313 may have different sampling rates. The sampling rates of the group of data transmitted and received by the key sensor unit 307, the key driving unit 309, and the pedal driving unit 313 can be adjusted by increasing or decreasing the number of channels assigned to the transmission and reception of the group of data. For example, as shown in FIG. 11, the sampling rate of the group of data transmitted and received by the key driving unit 309 is 6 kHz (SPS: 6,000), but the sampling rate can be doubled to 12 kHz (SPS: 12,000) by doubling the number of channels assigned to the transmission and reception of the group of data, that is, to 24 channels.

### [Modifications]

### [First Modification]

Although the channels are divided into the key sensor unit 307, the key driving unit 309, and the pedal driving unit 313, and the information handled by each of them is handled as a group of data at timings based on the respective sampling rates in the above-described embodiment, the present disclosure is not limited to this. For example, a pedal position sensor for detecting the position of the pedal may be provided with a musical instrument, position information from the pedal position sensor may be input to the key sensor unit 307, and the position information is put into any one or more of KEY88 to KEY95 containing the dummy data in FIG. 5 and the position information may be processed. In addition, the data transmitted and received is not limited to the information related to the control element a key, a pedal, or the like. For example, a temperature sensor for detecting the temperature of the solenoid that drives a key or a pedal may be provided, and the output of the temperature sensor may be put into any one or more of KDI88 to KDI95 in FIG. 9 to control the temperature of the solenoid.

### [Second Modification]

Although an example of an automatic playing piano that performs a performance by driving a key or a pedal has been described in the above-described embodiments, the present disclosure is not limited to this. For example, the present disclosure may be applied to an electronic keyboard instrument such as a muting piano or that generates musical sound by an electronic sound source a soundboard-exciting piano (for example, a trans-acoustic piano (registered trademark)), or an electronic piano or a synthesizer. In this case, if the music instrument does not drive keys or pedals, the key driving information, the pedal driving information, and their related information of the above-described example can be omitted. In addition, the present disclosure is not limited to an electronic keyboard instrument, and may be used to detect a key operation of an electronic wind instrument or to detect an operation of hitting a surface of an electronic percussion instrument. Furthermore, the present disclosure is not limited to a musical instrument, and may be applied to a device that processes data exceeding the number of channels at one time division timing.

What is claimed is:

1. A musical device comprising:
a plurality of sensors that detect a movement of a plurality of performance control elements, respectively, the plurality of performance control elements including at least three performance control elements;
a first transmitter that serially transmits identification information to identify a first group of data and the first group of data, using a first predefined number of data channels in time-division of a first predefined number of cycles, wherein the first group of data includes at least three pieces of data, the first predefined number of data channels includes at least two data channels, the first predefined number of cycles includes at least two cycles, a number of the plurality of performance control elements and a number of the pieces of data of the first group of data is larger than the first predefined number of data channels; and
a first receiver that identifies the first group of data from data serially received from the first transmitter based on the identification information,
wherein the first group of data includes information indicating a detection result output from each of the plurality of sensors.

2. The musical device according to claim 1, wherein the first group of data is a range of values excluding the identification information.

3. The musical device according to claim 1, wherein the first receiver has a counter that measures the number of pulses in a clock signal and identifies the first group of data from the data received from the first transmitter based on the identification information and a measurement result by the counter.

4. The musical device according to claim 1, further comprising:
a second transmitter that serially transmits identification information to identify a second group of data and the second group of data, using a second predefined number of data channels in time-division of a second predefined number of cycles, wherein the second group of data includes at least three pieces of data, the second predefined number of data channels includes at least two data channels, the second predefined number of cycles includes at least two cycles, and a number of the pieces of data of the second group of data is larger than the second predefined number of data channels; and
a second receiver that identifies the second group of data from data serially received from the second transmitter based on the identification information,
wherein the second predefined number of data channels is different from the first predefined number of data channels and/or the second predefined number of cycles is different from the first predefined number of cycles.

5. The musical device according to claim 1, wherein the identification information is transmitted with each transmission of the first group of data.

6. The musical device according to claim 1, wherein the identification information is transmitted with each transmission of a plurality of the first group of data.

7. A musical device comprising:
a plurality of driving units that drive a plurality of performance control elements, respectively, the plurality of performance control elements including at least three performance control elements;
a first transmitter that serially transmits identification information to identify a first group of data and the first group of data, using a first predefined number of data channels in time-division of a first predefined number of cycles, wherein the first group of data includes at least three pieces of data, the first predefined number of data channels includes at least two data channels, the first predefined number of cycles includes at least two cycles, and a number of the plurality of performance control elements and a number of the pieces of data of the first group of data is larger than the first predefined number of data channels; and
a first receiver that identifies the first group of data from data serially received from the first transmitter based on the identification information,
wherein the first group of data includes information for driving the plurality of performance control elements.

8. The musical device according to claim 7, wherein the first group of data is a range of values excluding the identification information.

9. The musical device according to claim 7, wherein the first receiver has a counter that measures the number of pulses in a clock signal and identifies the first group of data from the data received from the first transmitter based on the identification information and a measurement result by the counter.

10. The musical device according to claim 7, further comprising:
a second transmitter that serially transmits identification information to identify a second group of data and the second group of data, using a second predefined number of data channels in time-division of a second predefined number of cycles, wherein the second group of data includes at least three pieces of data, the second predefined number of data channels includes at least two data channels, the second predefined number of cycles includes at least two cycles, and a number of the pieces of data of the second group of data is larger than the second predefined number of data channels; and
a second receiver that identifies the second group of data from data serially received from the second transmitter based on the identification information,
wherein the second predefined number of data channels is different from the first predefined number of data channels and/or the second predefined number of cycles is different from the first predefined number of cycles.

11. The musical device according to claim 7, wherein the identification information is transmitted with each transmission of the first group of data.

12. The musical device according to claim 7, wherein the identification information is transmitted with each transmission of a plurality of the first group of data.

13. A musical device comprising:
a plurality of sensors that detect a movement of a plurality of performance control elements, respectively, the plurality of performance control elements including at least three performance control elements;
a first transmitter that serially transmits identification information assigned by a first receiver to identify a first group of data and the first group of data, using a first predefined number of data channels in time-division of a first predefined number of cycles, wherein the first group of data includes at least three pieces of data, the first predefined number of data channels includes at least two data channels, the first predefined number of cycles includes at least two cycles, and a number of the plurality of performance control elements and a number of the pieces of data of the first group of data is larger than the first predefined number of data channels; and
the first receiver that identifies the first group of data from data serially received from the first transmitter based on the identification information transmitted to the first transmitter,
wherein the first group of data includes information indicating a detection result output from each of the plurality of sensors.

14. The musical device according to claim 13, wherein values that the first group of data can take include a value of the identification information.

15. The musical device according to claim 13, wherein the first receiver has a counter that measures the number of pulses in a clock signal and divides the first group of data based on the identification information and a measurement result by the counter.

16. The musical device according to claim 13, further comprising:
a second transmitter that serially transmits identification information assigned by a second receiver to identify a second group of data and the second group of data, using a second predefined number of data channels in time-division of a second predefined number of cycles, wherein the second group of data includes at least three pieces of data, the second predefined number of data channels includes at least two data channels, the second predefined number of cycles includes at least two cycles, and a number of the pieces of data of the second group of data is larger than the second predefined number of data channels; and
the second receiver that identifies the second group of data from data serially received from the second transmitter based on the identification information transmitted to the second transmitter,
wherein the second predefined number of data channels is different from the first predefined number of data channels and/or the second predefined number of cycles is different from the first predefined number of cycles.

17. The musical device according to claim 13, wherein the identification information is transmitted with each transmission of the first group of data.

18. The musical device according to claim 13, wherein the identification information is transmitted with each transmission of a plurality of the first group of data.

19. A musical device comprising:
a plurality of driving units that drive a plurality of performance control elements, respectively, the plurality of performance control elements including at least three performance control elements;
a first transmitter that serially transmits identification information assigned by a first receiver to identify a first group of data and the first group of data, using a first predefined number of data channels in time-division of a first predefined number of cycles, wherein the first group of data includes at least three pieces of data, the first predefined number of data channels includes at least two data channels, the first predefined number of cycles includes at least two cycles, and a number of the plurality of performance control elements and a number of the pieces of data of the first group of data is larger than the first predefined number of data channels; and
the first receiver that identifies the first group of data from data serially received from the first transmitter based on the identification information transmitted to the first transmitter,
wherein the first group of data includes information for driving the plurality of performance control elements.

20. The musical device according to claim 19, wherein values that the first group of data can take include a value of the identification information.

21. The musical device according to claim 19, wherein the first receiver has a counter that measures the number of pulses in a clock signal and divides the first group of data based on the identification information and a measurement result by the counter.

22. The musical device according to claim 19, further comprising:
a second transmitter that serially transmits identification information assigned by a second receiver to identify a second group of data and the second group of data, using e a second predefined number of data channels in time-division of a second predefined number of cycles, wherein the second group of data includes at least three pieces of data, the second predefined number of data channels includes at least two data channels, the second predefined number of cycles includes at least two cycles, and a number of the pieces of data of the second group of data is larger than the second predefined number of data channels; and
the second receiver that identifies the second group of data from data serially received from the second transmitter based on the identification information transmitted to the second transmitter,
wherein the second predefined number of data channels is different from the first predefined number of data channels and/or the second predefined number of cycles is different from the first predefined number of cycles.

23. The musical device according to claim 19, wherein the identification information is transmitted with each transmission of the first group of data.

24. The musical device according to claim 19, wherein the identification information is transmitted with each transmission of a plurality of the first group of data.
